(19) United States
(12) Patent Application Publication
(10) Pub. No.: US 2011/0258557 A1
(43) Pub. Date: Oct. 20, 2011

(54) PERSONAL STREAMING AND BROADCAST CHANNELS IN A MEDIA EXCHANGE NETWORK

(76) Inventors: Jeyhan Karaoguz, Irvine, CA (US); James D. Bennett, Laguna Beach, CA (US)

(21) Appl. No.: 13/113,022

(22) Filed: May 20, 2011

Related U.S. Application Data
(63) Continuation of application No. 10/675,410, filed on Sep. 30, 2003.
(60) Provisional application No. 60/482,478, filed on Jun. 25, 2003.
(60) Provisional application No. 60/432,472, filed on Dec. 11, 2002.
(60) Provisional application No. 60/443,894, filed on Jan. 30, 2003.

(51) Int. Cl. G06F 3/01; G06F 15/16

(52) U.S. Cl. 715/751

(57) ABSTRACT

Systems and methods for the exchange of personal streaming media channels are disclosed. An embodiment of the present invention may permit the exchange of media such as, for example, audio and video, in a real time manner via a personal media channel in a media exchange network. The media channel may be established based upon input from a user, and its establishment may be initiated based upon input from sensors such as, for example, a smoke or fire sensor, a motion detector, a swimming pool disturbance detector, and a door bell button. A personal streaming media channel may be a one-way or a two-way channel. The media may be consumed using a set top box, and may be produced by a media peripheral such as, for example, a digital camcorder, a microphone, a video camera, and a MP3 player.

### CROSS-REFERENCE TO RELATED APPLICATIONS/INCORPORATION BY REFERENCE

This application makes reference to, claims priority to, and claims the benefit of U.S. Provisional Patent Application Ser. No. 60/482,478, entitled “Personal Streaming And Broadcast Channels In A Media Exchange Network” (Attorney Docket 14543US01 01055P-BP-2980), filed Jun. 25, 2003, U.S. Provisional Application Ser. No. 60/432,472, entitled “Personal Inter-Home Media Exchange Network” (Attorney Docket No. 14185US01 01001 P-BP-2800), filed Dec. 11, 2002, and U.S. Provisional Application Ser. No. 60/443,894, entitled “Personal Access And Control Of Media Peripherals On A Media Exchange Network” (Attorney Docket No. 14274US01 01002P-BP-2801), filed Jan. 30, 2003, the complete subject matter of which are hereby incorporated herein by reference, in their entirety.

In addition, the applicants hereby incorporate the complete subject matter herein by reference, in their entirety, of U.S. Provisional Patent Application Ser. No. 60/461,717, entitled “Secure Media Peripheral Association With Authentication In A Media Exchange Network” (Attorney Docket No. 14824US01 01012P-BP-2830), filed Apr. 10, 2003, U.S. Provisional Patent Application Ser. No. 60/448,705, entitled “Media Exchange Network With Media Guide Interface” (Attorney Docket No. 14330US01 01018P-BP-2819), filed Feb. 18, 2003, U.S. Provisional Patent Application Ser. No. 60/457,179, entitled “Server Architecture Supporting A Personal Media Exchange Network” (Attorney Docket No. 14825US01 01015P-BP-2831), filed Mar. 25, 2003, U.S. patent application Ser. No. ______, entitled “Personal Inter-Home Media Exchange Network” (Attorney Docket No. 14185US02 01001P-BP-2800), filed Sep. 8, 2003, and U.S. patent application Ser. No. ______, entitled “Personal Access And Control Of Media Peripherals On A Media Exchange Network” (Attorney Docket No. 14274US02 01002P-BP-2801), filed Sep. 11, 2003.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

The vast majority of interpersonal communication takes place in the form of speech. When two people wish to communicate over a distance, they typically use the telephone. If the ability to transmit a live image is necessary, the use of a device such as a video telephone, or “videophone”, is usually called for. Videophones are available that work over the standard public switched telephone network (PSTN), but their cost is considerably higher than a standard voice telephone, and the picture is typically low quality. This results from the severe bandwidth limitations imposed by the voice telephone network.

Visual communication is sometimes accomplished using personal computer (PC)-based video telephony via the Internet. With PC-based video telephony, the image of the near-end participant is captured by a camera connected to the PC, while the image of the far-end party is displayed on the PC monitor. The user may connect using a dial-up (PSTN) connection, or a higher bandwidth cable Internet or digital subscriber loop (DSL) connection. PC-based video telephony over a dial-up connection suffers from the same low level of quality experienced with stand-alone videophone devices, due to the limited bandwidth available. PC-based video telephony over a cable internet or DSL connections can provide improved image quality, but requires cable Internet or DSL service. To make use of PC-based video telephony, both the near-end and far-end parties must be sufficiently computer-savvy to equip their personal computers with a suitable video camera, must have the correct software installed, and must have an appropriate communication network connection. The use of the PC monitor as the display device limits use to those that can huddle in front of the PC. In addition, a large segment of the population do not feel comfortable using a PC, not to mention installing new software or adding new peripherals such as a video camera, or a cable or DSL modem.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention may be found in a system supporting the exchange of media in a communication network. Such a system may comprise a first television display, at a first home, to support the consumption of media, and at least one first media peripheral, at the first home, for the production of media. An embodiment may comprise a first storage, at the first home, for storing media, and a first set top box circuitry, at the first home. The first storage may be communicatively coupled to the first television display. The first set top box circuitry may communicatively couple the first television display and the at least one first media peripheral to the communication network, and the first set top box circuitry may have an associated first network address. Such an embodiment may also comprise a user interface, at the first home, having at least one view comprising a representation of at least one user defined media channel for the exchange of media, and a second television display, at a second home. The second television display may support the consumption of media.

In addition, an embodiment of the present invention may comprise a second set top box circuitry, at the second home, communicatively coupling the second television display to the communication network. The second set top box circuitry may have an associated second network address. An embodiment in accordance with the present invention may also comprise server software that receives a request identifying one of the first and second associated network addresses. The server software may respond by identifying the other of the associated first and second network addresses to support exchange of the media from the at least one first media peripheral to the second television display for consumption in a real time manner.

In an embodiment of the present invention, the media may comprise at least one of audio, a still image, video, and data, and consumption may comprise at least one of playing digitized audio, displaying a still image, displaying video, and displaying data. The associated first and second network addresses may be one of an Internet protocol (IP) address, a media access control (MAC) address, and an electronic serial number (ESN). The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure, and the communication network may be the Internet. The at least one first media peripheral may comprise at least one of a digital camera, a digital camcorder, a video camera, a television, a personal computer, a CD player, a home juke-box, a multi-media gateway device, a multi-media personal digital assistant, a DVD player, a tape player, a microphone, and a MP3 player.

An embodiment of the present invention may comprise at least one second media peripheral, at the second home, for the production of media, and server software that receives a request identifying one of the first and second associated network addresses. The server software may respond by identifying the other of the associated first and second network addresses, and may support exchange of the media from the at least one second media peripheral to the first television display for consumption in a real time manner. The at least one second media peripheral may comprise at least one of a digital camera, a digital camcorder, a video camera, a television, a personal computer, a CD player, a home juke-box, a multi-media gateway device, a multi-media personal digital assistant, a DVD player, a tape player, a microphone, and a MP3 player. In an embodiment in accordance with the present invention, the exchange of the media from the at least one first media peripheral to the second television display, and the exchange of the media from the at least one second media peripheral to the first television display, may occur concurrently.

An embodiment of the present invention may comprise at least one sensor for detecting a condition, at the first home, and the detection of the condition may cause the initiation of a request to exchange media with the second home. The at least one sensor may comprise at least one of a door bell button, a passive infrared (PIR) motion detector, a microwave motion detector, a swimming pool water disturbance detector, a smoke detector, a fire detector, or other sensor suitable for the detection of conditions about a home.

Additional aspects of the present invention may be seen in a system supporting the exchange of media in a communication network. A system in accordance with the present invention may comprise at least one media peripheral, at a first home, for the production of media, and a first set top box circuitry, at the first home, communicatively coupling the at least one media peripheral to the communication network. An embodiment of the present invention may comprise a television display, at a second home, for the consumption of media, and a second set top box circuitry, at the second home, communicatively coupling the television display to the communication network. Such an embodiment may comprise a user interface, at the second home, having at least one view comprising a representation of at least one user defined media channel for the exchange of media. In addition, an embodiment of the present invention may comprise server software that receives a request, and that responds by coordinating an exchange of media from the at least one media peripheral to the second television display for consumption in a real time manner.

In various embodiment of the present invention, the media may comprise at least one of audio, a still image, video, and data. The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure. The at least one media peripheral may comprise at least one of a digital camera, a digital camcorder, a video camera, a television, a personal computer, a CD player, a home juke-box, a multi-media gateway device, a multi-media personal digital assistant, a DVD player, a tape player, a microphone, and a MP3 player. Consumption may comprise at least one of playing digitized audio, displaying a still image, displaying video, and displaying data. An embodiment of the present invention may also comprise at least one sensor for detecting a condition, at the first home, and the detection of the condition may cause the initiation of a request to exchange media with the second home. The at least one sensor may comprise at least one of a door bell button, a passive infrared (PIR) motion detector, a microwave motion detector, a swimming pool water disturbance detector, a smoke detector, a fire detector, or other sensor suitable for the detection of conditions about a home.

Further aspects of the present invention may be observed in method of supporting the exchange of media in a communication network. An embodiment of the present invention may comprise receiving input from a user, at a first location, and transmitting a request to exchange media, to a second location, via the communication network. An embodiment of the present invention may also comprise authenticating the first location to the second location, receiving an acceptance from the second location, and exchanging media in a real time manner, via the communication network, between the first location and the second location. The media may comprise at least one of audio, a still image, video, and data. The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure. In an embodiment of the present invention, the user input may be received via a user interface having at least one view comprising a representation of at least one user defined media channel for the exchange of media. The authenticating may use a digital certificate, and the exchange of media may be a concurrent two-way exchange.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating a media exchange network in which an embodiment of the present invention may be practiced.

FIG. 1B is a block diagram illustrating an exemplary embodiment of a media exchange network supporting personal streaming and broadcast channels in a media exchange network, in accordance with the present invention.

FIG. 1C is a diagram illustrating an exemplary embodiment of a media guide interface supporting personal streaming and broadcast channels in a media exchange network, in accordance with the present invention.

FIG. 2 is a flowchart illustrating an exemplary method of establishing a two-way streaming video and audio media channel in a media exchange network, in accordance with the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a media guide user interface in accordance with an embodiment of the present invention.

FIG. 7 is an exemplary illustration of several instantiations of a media guide user interface of FIG. 4 in accordance with an embodiment of the present invention.

FIG. 8 is an exemplary illustration of a media guide user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to providing support for the exchange of streaming media. In particular, certain embodiments of the present invention enable the exchange of streaming and broadcast media channels in a media exchange network.

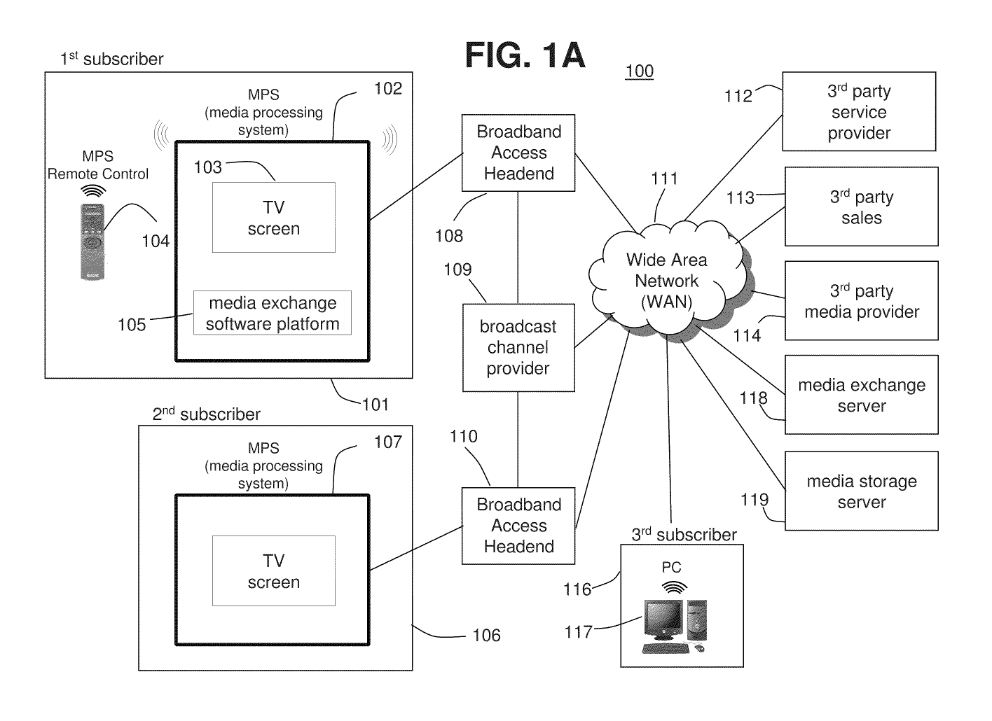

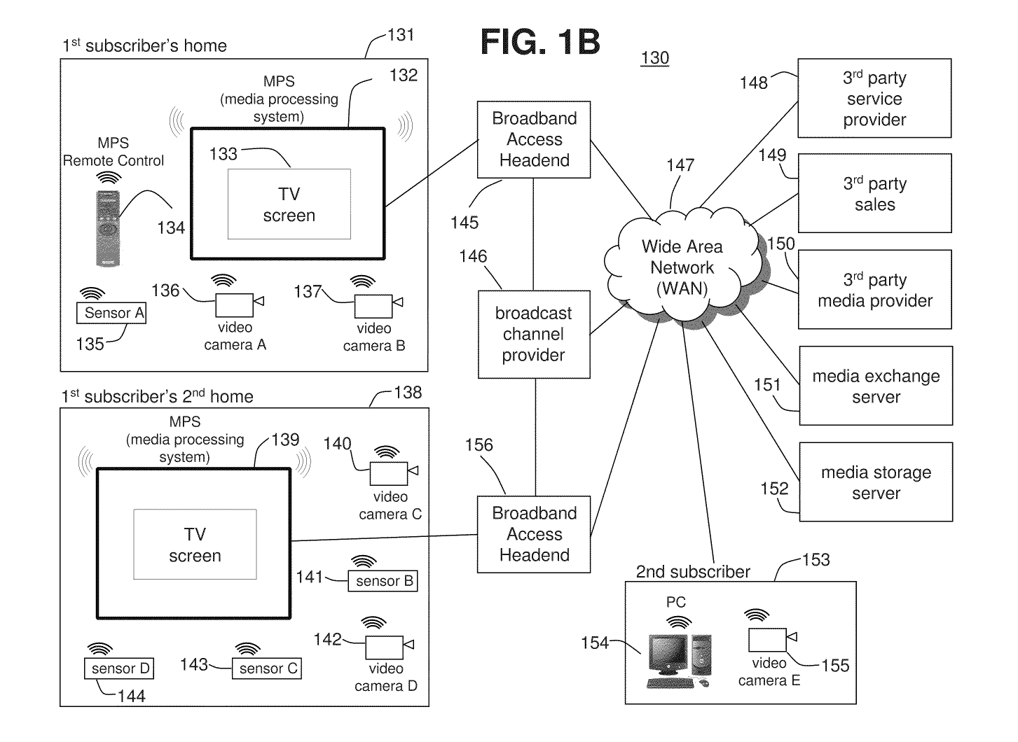

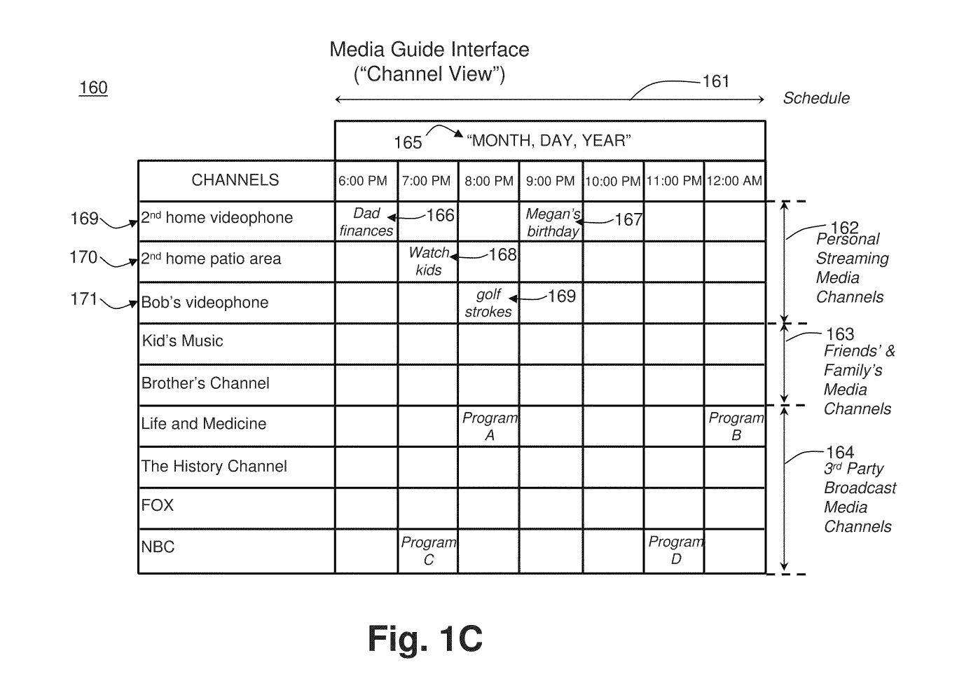

FIG. 1A is a block diagram illustrating a media exchange network 100 in which an embodiment of the present invention may be practiced. The media exchange network 100 is a communication network comprising a MPS (media processing system) 102 at a 1st subscriber 101, a MPS 107 at a 2^{nd} subscriber 106, and a PC 117 at a third subscriber 116. The MPS 102 is connected to broadband access headend 108 that connects to WAN infrastructure 111. Likewise, the MPS 107 is connected to broadband access headend 110 that provides connectivity to WAN infrastructure 111. The media exchange network 100 further comprises a 3^{rd} party service provider 112, a 3^{rd} party sales provider 113, a 3^{rd} party media provider 114, a media exchange server 118, a media storage server 119, and a broadcast channel provider 109. Wide-area network (WAN) infrastructure 111 provides connectivity between the MPS's 102, 107 and the PC 117, and permits access to 3rd party service provider 112, 3^{rd} party sales provider 113, 3^{rd} party media provider 114, the media exchange server 118, the media storage server 119, and broadcast channel provider 109. The fact that illustration of FIG. 1A shows two MPS's 102, 107 and a single PC 117 is not intended to represent a limitation of the present invention. The media exchange network 100 may comprise any number of MPS's and PC's without departing from the spirit and scope of the present invention. Each of the entities within the media exchange network 100 may be identified using a network or protocol address such as, for example, an Internet protocol (IP) address, a media access control (MAC) address, and an electronic serial number (ESN).

The MPS's 102, 107 may be, for example, enhanced set-top-boxes. The MPS's 102, 107 may each include a TV screen such as the TV screen 103 of the MPS 102 for viewing and interacting with various user interfaces, media, data, and services that are available on the media exchange network 100 using, for example, a remote control such as the remote control 104 associated with the MPS 102. The PC 117 may include a PC monitor for viewing and interacting with various user interfaces, media, data, and services that are available on the media exchange network using, for example, a keyboard and mouse. The MPS's 102, 107 and the PC 117 include functional software to support interaction with the various elements of the media exchange network 100, in accordance with various embodiments of the present invention.

In accordance with various embodiments of the present invention, a MPS may comprise a set-top-box (STB), a PC, or a TV with a media management system (MMS). A MMS is also known herein as a media exchange software (MES) platform.

A MMS comprises a software platform operating on at least one processor to provide certain functionality including user interface functionality, distributed storage functionality, and networking functionality. For example, a MMS may provide control of media peripheral devices, status monitoring of media peripheral devices, and inter-home MPS routing selection, in accordance with an embodiment of the present invention.

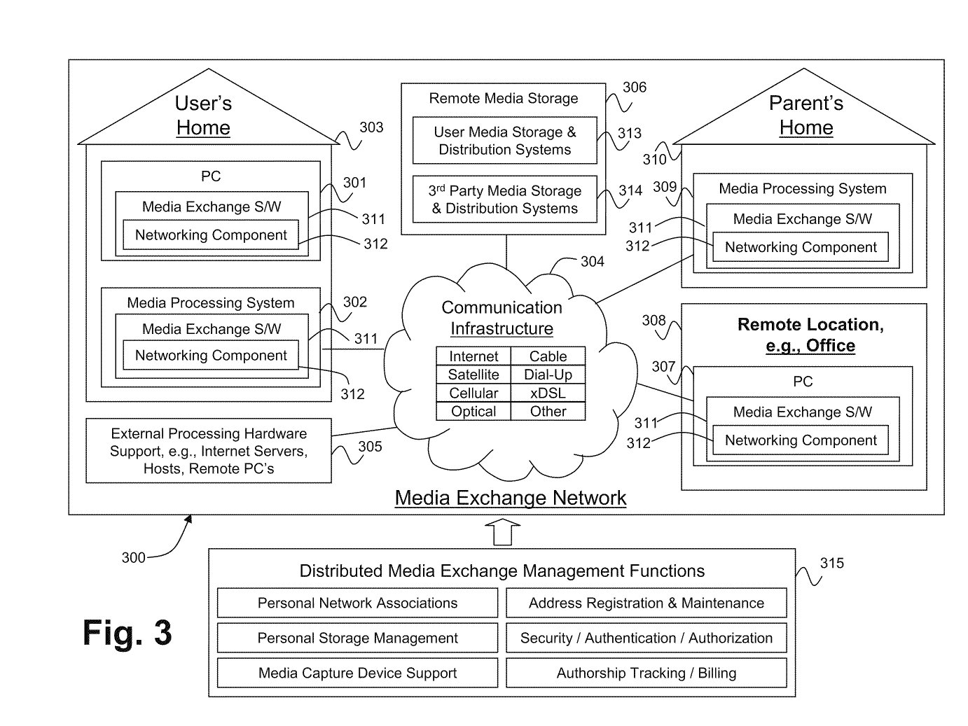

For example, the MPS's 102, 107 and the PC 117 comprise a media exchange software (MES) platform 105. Further details of a media exchange software platform are provided below with respect to FIG. 3. The MES platform 105 on the MPS 102, and similarly the MES platforms on MPS 107 and PC 117, support personalized views of media channels and the set up of new media channels on the media exchange network 100. For example, the MES platform 105 provides a format, displayed on a monitor of the MPS 102, comprising a media guide user interface, or “channel view”, to allow a user to set up a personalized view of the media guide user interface using a remote control 104. An example media guide user interface is described in U.S. Provisional Patent Application Ser. No. 60/448,705, entitled “Media Exchange Network With Media Guide Interface” (Attorney Docket No. 14330US01 01018P-BP-2819), filed Feb. 18, 2003, the complete subject matter of which is hereby incorporate herein in its entirety. The MES platform 105 also provides the functionality for a user of the MPS 102 to set up one or more media channels in his personalized view.

In general, the MPS's 102, 107 and the PC 117 each include a media exchange software (MES) platform and a networking component for connectivity. The MES platform provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface with a TV channel guide look-and-feel.

FIG. 1B is a block diagram illustrating an exemplary embodiment of a media exchange network 130 supporting personal streaming and broadcast channels in a media exchange network, in accordance with the present invention. The media exchange network 130 of FIG. 1B is similar to the media exchange network 100 of FIG. 1A, and comprises a MPS 132 at a 1st subscriber's home 131, a MPS 139 at a 1^{st} subscriber's 2^{nd} home 138, and a PC 154 at a 2^{nd} subscriber 153. The media exchange network 130 further comprises a 3^{rd} party service provider 148, a 3^{rd} party sales provider 149, a 3^{rd} party media provider 150, a media exchange server 151, a media storage server 152, and a broadcast channel provider 146. The wide-area network (WAN) infrastructure 147 provides connectivity between the MPS's 132, 139 and the PC 154, and permits access to 3^{rd} party service provider 148, 3^{rd} party sales provider 149, 3^{rd} party media provider 150, media exchange server 151, and media storage server 152. The WAN infrastructure 147 may comprise, for example, a wired network infrastructure, a wireless network infrastructure, an intranet infrastructure, an Internet infrastructure, a digital subscriber loop (DSL) infrastructure, or any combination of the above. Although the illustration of FIG. 1B shows a particular complement of MPS's and PC's, the present invention is not limited in this regard.

The MPS's 132, 139 of FIG. 1B may be, for example, an enhanced set-top-box and may include a TV screen and a remote control, such as the TV screen 103 and remote control 104 of the MPS 102 illustrated in FIG. 1A. The PC 154 may include a PC monitor, a keyboard, and mouse. The MPS's 132, 139 and the PC 151 include functional software to support interaction with the various elements of the media exchange network 130, in accordance with various embodiments of the present invention.

In addition to the elements described above, the exemplary media exchange network 130 of FIG. 1B comprises a number of media peripherals at the 1^{st} subscriber's home 131, the 1^{st} subscriber's 2^{nd} home 138, and the 2^{nd} subscriber 153. At the 1^{st} subscriber's home 131, a sensor A 135, a video camera A 136, and a video camera B 137 are located in proximity to the MPS 132 and may be in communication with the MPS 132 via a wired or wireless link compliant with, for example, the IEEE 802.11a/b/g or related wireless network standard, or the Bluetooth wireless network protocol. In an embodiment of the present invention, the sensor A 135 may be any of, for example, a door bell button, a passive infrared (PIR) or microwave motion detector, a swimming pool water disturbance detector, a smoke or fire detector, or other sensor suitable for the detection of conditions about a home. The video camera A 136 may be, for example, a color or black-and-white video camera located in close proximity to the MPS 132, and may have its field of view trained on a viewer of the TV screen 133. The video camera B 137 may be, for example, a miniaturized color or low-light camera located near the front door, the patio area, the driveway, or other interior or exterior area of the 1^{st} subscriber's home 131, and may be positioned such that its field of view captures an image of an area of interest at the 1^{st} subscriber's home 131. Although the illustration of FIG. 1B shows a particular complement of media peripherals linked to the MPS 132, a different number or complement of media peripherals may be linked to the MPS 132 without departing from the spirit of the present invention.

Continuing with respect to FIG. 1B, the 1^{st} subscriber's 2^{nd} home 138 may comprise a video camera C 140, a sensor B 141, a video camera D 142, a sensor C 143, and a sensor D 144. The video camera C 140, sensor B 141, video camera D 142, sensor C 143, and sensor D 144 are located in proximity to the MPS 139 and may communicate with the MPS 139 via a wired or wireless link compliant with, for example, the IEEE 802.11a/b/g or related wireless network standard, or the Bluetooth wireless network protocol. The sensors B 141, C 143, and D 144 may be any of, for example, a door bell button, a passive infrared (PIR) or microwave motion detector, a swimming pool water disturbance detector, a smoke or fire detector, or other sensors suitable for the detection of conditions about a home. The video camera C 140 may be, for example, a color or black-and-white video camera located in close proximity to the MPS 139, and may have its field of view trained on a viewer of the TV screen of the MPS 139. The video camera D 142 may be, for example, a miniaturized color or low-light camera located near the front door, the patio area, the driveway, or other interior or exterior area of the 1^{st} subscriber's 2^{nd} home 138, and may be positioned such that its field of view captures an image of an area of interest at the 1^{st} subscriber's 2^{nd} home 138. Although the illustration of FIG. 1B shows a particular complement of media peripherals linked to the MPS 139, a different number or complement of media peripherals may be associated with the MPS 139 without departing from the spirit or scope of the present invention.

The 2^{nd} subscriber 153 shown in FIG. 1B may comprise a PC 154 and a video camera 155. The PC 154 includes functional software to support interaction with the various elements of the media exchange network 130, in accordance with various embodiments of the present invention. The video camera 155 may be linked either through a wired or wireless connection to the PC 154, and may be positioned in order to capture an image of a user of the PC 154. Although the complement of media peripherals illustrated in FIG. 1B at the 2^{nd} subscriber 153 is considerably less than that illustrated for the 1^{st} subscriber's home 131 and the 1^{st} subscriber's 2^{nd} home 138, this is for reasons of simplification of the illustration, and does not represent a limitation of the present invention.

An embodiment in accordance with the present invention permits a user of a MPS such as MPS's 132, 139, or a PC such as the PC 154 to establish a personal streaming channel with another MPS or PC on media exchange network 130 for the exchange of live video. A streaming channel is a media channel in which the media is transferred in a real time manner, without significant delay from the source to the destination. A personal streaming channel is a streaming channel that is defined or established by a user for the exchange of media with other designated users of a media exchange network such as, for example, media exchange network 130. A personal streaming channel may be a one-way or a two-way media channel. To more clearly illustrate the establishment and use of such a personal streaming channel, the following example is offered with respect to FIG. 1B. In this example, a user of the MPS 132 at 1^{st} subscriber home 131 establishes a personal two-way streaming video channel for live visual communication with a user of the PC 154 at 2^{nd} subscriber 153. The user of the MPS 132 may establish such a personal streaming channel using a media guide interface, an example of which is discussed below with respect to FIG. 1C. A media guide interface may be viewed on a display such as, for example, the TV screen 133 of the MPS 132 of FIG. 1B. A user of the MPS 132 may select a two-way streaming video channel to the PC 154 at 2^{nd} subscriber 153 using the media guide interface, and an input device such as the remote control 134.

When an entry representing the PC 154 at 2^{nd} subscriber 153 is selected from the media guide displayed at the MPS 132, the MPS 132 sends a request to establish a two-way streaming video channel to the PC 154 via the broadband access headend 145 and the WAN infrastructure 147. Upon receiving the request, the PC 154 alerts the user by providing, for example, an audio announcement, a pop-up window or graphic, an illuminated light emitting diode (LED), or some other form of annunciator. The user of the PC 154 then accepts the request for a two-way streaming video channel using, for example, a mouse or keyboard, or a spoken command captured by a microphone (not shown) connected to the PC 154. In response to the user acceptance, the PC 154 transmits an acceptance of the request to the MPS 132 via the WAN infrastructure 147 and the broadband access headend 145. The PC 154 then begins transmitting on the selected streaming channel video from, for example, the video camera 155 connected to the PC 154, and waits for receipt of streaming video from the MPS 132.

The acceptance received from the PC 154 prompts the MPS 132 to begin transmitting to the PC 154 a streaming video channel containing images from, for example, video camera A 136. The MPS 132 also begins displaying on the TV screen 133 the streaming video received from the PC 154 at 2^{nd} subscriber 153.

In another embodiment of the present invention, a one-way streaming video and audio channel from the MPS 139 at 1^{st} subscriber 2^{nd} home 138 to the MPS 132 at 1^{st} subscriber home 131 may be activated by a sensor such as sensors B 141, C 143, or D 144 at the 1^{st} subscriber 2^{nd} home 138. In such an embodiment, a sensor may react to the disturbance of the water in a swimming pool, the detection of smoke or fire, or the detection of an intruder within 1^{st} subscriber 2^{nd} home 138. For example, let us assume that sensor B 141 is a motion detector located within the 1^{st} subscriber 2^{nd} home 138, and that video camera C 140 is positioned such that its field of view coincides with the coverage area of sensor B 141. Upon the detection of an intruder, sensor B 141 sends a signal to the MPS 139 causing the MPS 139 to send a request for a one-way streaming video and audio channel from 1^{st} subscriber 2^{nd} home 138 to the MPS 132 at 1^{st} subscriber home 131 through broadband access headend 156, the WAN infrastructure 147, and broadband access headend 145. Upon receipt of the request, the MPS 132 at the 1^{st} subscriber home 131 transmits an acceptance back to the MPS 139 at 1^{st} subscriber 2^{nd} home 138 via the broadband access headend 145, the WAN infrastructure 147, and the broadband access headend 156, and waits for receipt of streaming video and audio. The receipt of the acceptance causes the MPS 139 to begin transmitting images from video camera C 140 and sound from an accompanying microphone (not shown) to the MPS 132 via the established one-way streaming video and audio channel. Such an embodiment permits a user at the 1^{st} subscriber home 131 to monitor the activity at the 1^{st} subscriber 2^{nd} home 138 that triggered the sensor B 141.

In yet another embodiment, the sensor A 135 at the 1^{st} subscriber home 131 may be, for example, a doorbell button located at the front door of the 1^{st} subscriber home 131. The video camera A 136 and microphone are positioned to pick up the image and voice of a person at the front door of 1^{st} subscriber home 131. In such an embodiment, the activation of the doorbell button (sensor A 135) may cause the MPS 132 at the 1^{st} subscriber home 131 to establish a two-way streaming channel carrying both video and audio to the MPS 139 at the 1^{st} subscriber 2^{nd} home 138. The streaming channel also carries the speech audio from the user at the 1^{st} subscriber 2^{nd} home 138 to a loudspeaker (not shown) adjacent to the doorbell button (sensor A 135) at the 1^{st} subscriber home 131. In this manner, an embodiment in accordance with the presence invention enables a user to remotely interact with visitors to their homes, businesses, etc., using live video and audio.

In another embodiment in accordance with the present invention, a personal broadcast channel may be established to share, for example, streaming audio and/or video with multiple parties. For instance, a user at 1^{st} subscriber's home 131 may establish a streaming audio and/or video channel to both the MPS 139 at 1^{st} subscriber's 2^{nd} home 138 and with the PC 154 at the 2^{nd} subscriber 153. In this manner, a user of an MPS or a PC may make a streaming media channel available to multiple users of MPS's or PC's such as the MPS's 132, 139 and the PC 154 of FIG. 1B.

An example method for access and control of media peripherals such as the video cameras A 136, B 137, C 140, D 142, and E 155, and sensors A 135, B 141, C 143, and D 144 is described in U.S. Provisional Application Ser. No. 60/443,894, entitled “Personal Access And Control Of Media Peripherals On A Media Exchange Network” (Attorney Docket No. 14274US01 01002P-BP-2801), filed Jan. 30, 2003, the complete subject matter of which is hereby incorporated herein by reference, in its entirety.

In an embodiment in accordance with the present invention, the authentication and authorization functionality for the secure transfer of digital information between, for example, the sensor A 135, the video camera A 136, and the video camera B 137, and the MPS 132 of FIG. 1B may be enabled using digital certificates. The digital certificates may be embedded in the firmware or hardware of the sensor A 135, the video camera A 136, and the video camera B 137. The digital certificates may comprise certain, information including, for example, a device ID, a public key for encryption, and possible other information related to services, payment terms, billing, and media push/access restrictions and limitations. An example of a system for securing transfer of digital media content in a media exchange network is described in U.S. Provisional Patent Application Ser. No. 60/461,717, entitled “Secure Media Peripheral Association With Authentication In A Media Exchange Network” (Attorney Docket No. 14824US01 01012P-BP-2830), filed Apr. 10, 2003, the complete subject matter of which is hereby incorporated herein by reference, in its entirety.

FIG. 1C is a diagram illustrating an exemplary embodiment of a media guide interface 160 supporting personal streaming and broadcast channels in a media exchange network, in accordance with the present invention. A media guide interface in accordance with that shown in FIG. 1C is described in U.S. Provisional Patent Application Ser. No. 60/448,705, entitled “Media Exchange Network With Media Guide Interface” (Attorney Docket No. 14330US01 01018P-BP-2819), filed Feb. 18, 2003, the complete subject matter of which is hereby incorporate herein, in its entirety. The diagram of FIG. 1C shows a media guide interface 160 in a tabular format comprising rows representing media channels, and columns containing program schedule information 161 for the date indicated by time period indicator 165. The media guide interface 160 is suitable for display on, for example, a TV screen or PC monitor such as the TV screen 133 of the MPS 132 or the PC monitor of the PC 154, both of which are illustrated in FIG. 1B.

The media guide interface 160 of FIG. 1C comprises “Personal Streaming” media channels 162, “Friends' and Family's” media channels 163, and “3^{rd} Party Broadcast” media channels 164. In the example shown in the illustration of FIG. 1C, the “Personal Streaming” media channels 162 comprise three streaming media channels designated “2^{nd} home videophone” 169, “2^{nd} home patio area” 170, and “Bob's videophone” 171. For the purposes of the illustration of FIG. 1C, let us assume that Dad and Mom are at 1^{st} subscriber's home 131, and their son and his family are using Dad's and Mom's vacation home, 1^{st} subscriber's 2^{nd} home 138. Dad has scheduled two, two-way streaming video and audio sessions on the first streaming media channel, “2^{nd} home videophone” 169. The first session, “Son finances” 166, is scheduled to begin at 6:00 PM on the date indicated by time period indicator 165. Dad has scheduled this session to discuss his retirement finances with his son. At 6:00 PM, the MPS 132 of FIG. 1B will automatically establish a two-way streaming video and audio media channel with the MPS 139 at 1^{st} subscriber 2^{nd} home 138. Dad and his son can then interactively view and discuss the documents that Dad has regarding his retirement plans. The second two-way streaming video and audio media channel, “Megan's birthday” 167, is scheduled for later that evening. At 9:00 PM, Dad and Mom at the 1^{st} subscriber's home 131 and the son and his family at the 1^{st} subscriber's 2^{nd} home 138 will celebrate the birthday of one of the children, “Megan”, sharing the experience using two-way “2^{nd} streaming video and audio supported over the streaming media channel home videophone” 169.

The second streaming media channel, “2^{nd} home patio” 170, has a single one-way streaming video session scheduled for 7:00 PM, “Watch kids” 168. At 7:00 PM, the MPS 132 at 1^{st} subscriber's home 131 will send a request to the MPS 139 at 1^{st} subscriber's 2^{nd} home 138 to establish a one-way streaming video and audio session from 1^{st} subscriber's 2^{nd} home 138 to the 1^{st} subscriber's home 131. The video from video camera D 142, that overlooks the patio and pool area at 1^{st} subscriber's 2^{nd} home 138 will be transmitted to 1^{st} subscriber home 131, so that Dad and Mom can enjoy watching their son's children enjoying the pool.

The last of the three “Personal Streaming” media channels 162, “Bob's videophone” 171, is scheduled for a session, “golf strokes” 169, at 8:00 PM. At the scheduled time, the MPS 132 at 1^{st} subscriber's house 131 will establish a two-way streaming video and audio media channel with the PC 154 at the 2^{nd} subscriber 153. Dad has scheduled this session so that his friend Bob can go over some improved golf strokes. The two-way streaming video and audio session provided by streaming media channel “Bob's videophone” 171 will permit Dad to see and hear the details of what Bob has to show Dad about the new golf stroke techniques, while allowing Dad to ask questions, and have Bob review Dad's grip and stance.

Although the example streaming media channels described above with respect to FIG. 1C have all been scheduled ahead of their activation, this is not a limitation of the present invention. A user of a media guide such as media guide 160 may choose at any time to activate any of the personal streaming channels shown on the media guide. This may be accomplished on a MPS such as the MPS 132 of FIG. 1B using, for example, a display such as TV screen 133, and an input device such as remote control 134. In an embodiment in accordance with the present invention, the cost of the streaming media channel may be reduced, however, if its use is scheduled in advance.

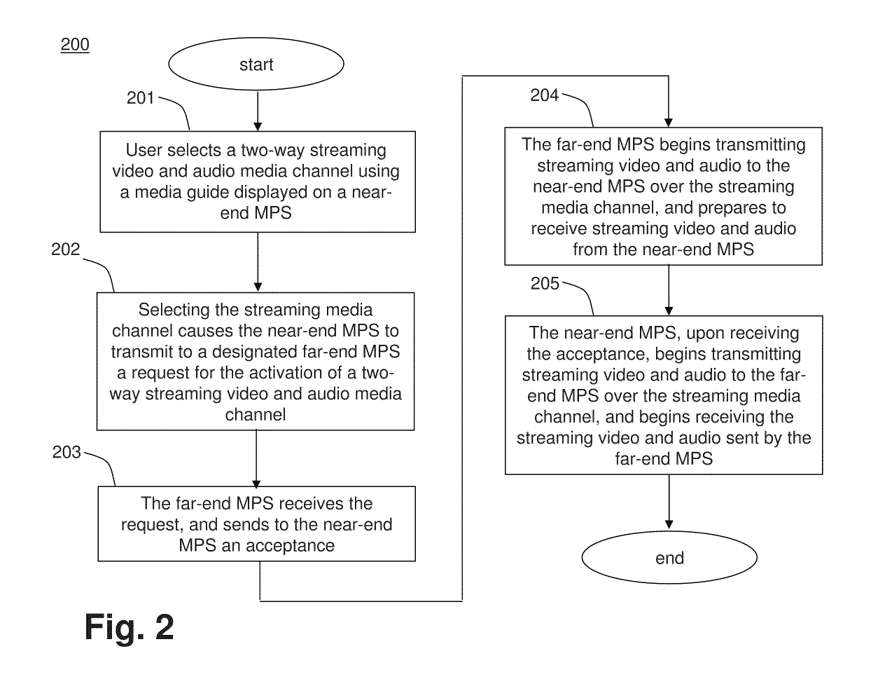

FIG. 2 is a flowchart illustrating an exemplary method of establishing a two-way streaming video and audio media channel in a media exchange network, in accordance with the present invention. The following example will describe the actions of two MPS's, one being a “near-end” MPS, and the other being a “far-end” MPS. The terms “near-end” and “far-end” are used only for the purpose of identifying the two MPS's in this example.

The method begins when a user selects a two-way streaming video and audio media channel using a media guide displayed on a near-end MPS (block 201). The action of selecting the streaming media channel causes the near-end MPS to transmit to a designated far-end MPS a request for the activation of a two-way streaming video and audio media channel (block 202). The far-end MPS receives the request, and sends to the near-end MPS an acceptance (block 203). The far-end MPS also begins transmitting streaming video and audio to the near-end MPS over the streaming media channel, and prepares to receive streaming video and audio from the near-end MPS (block 204). The near-end MPS, upon receiving the acceptance, begins transmitting streaming video and audio to the far-end MPS over the streaming media channel, and begins receiving the streaming video and audio sent by the far-end MPS (block 205). The two-way streaming video and audio media channel is now established.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

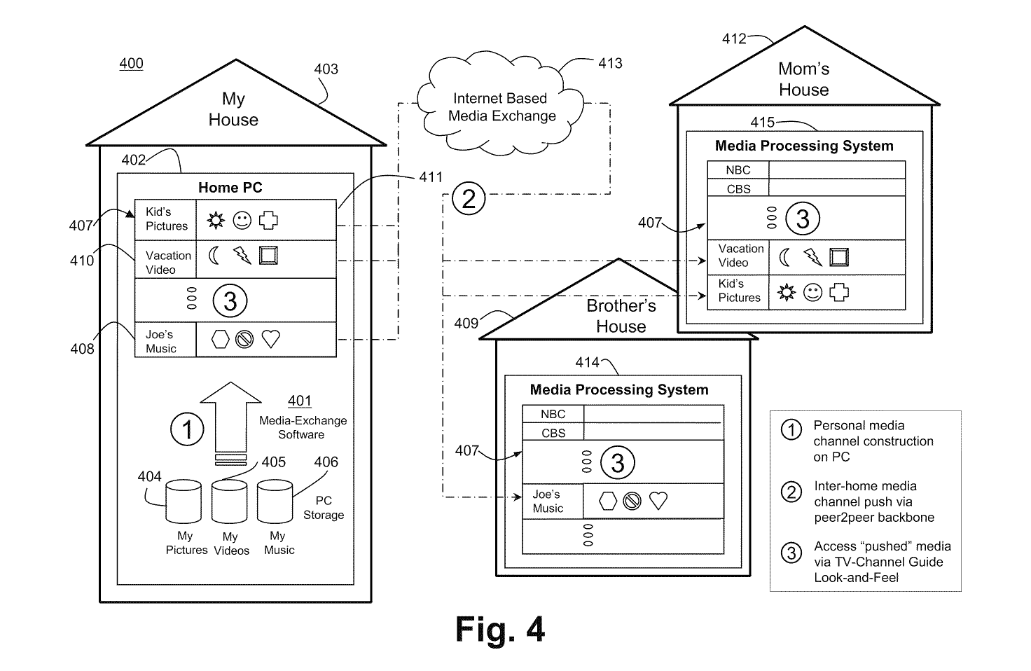

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

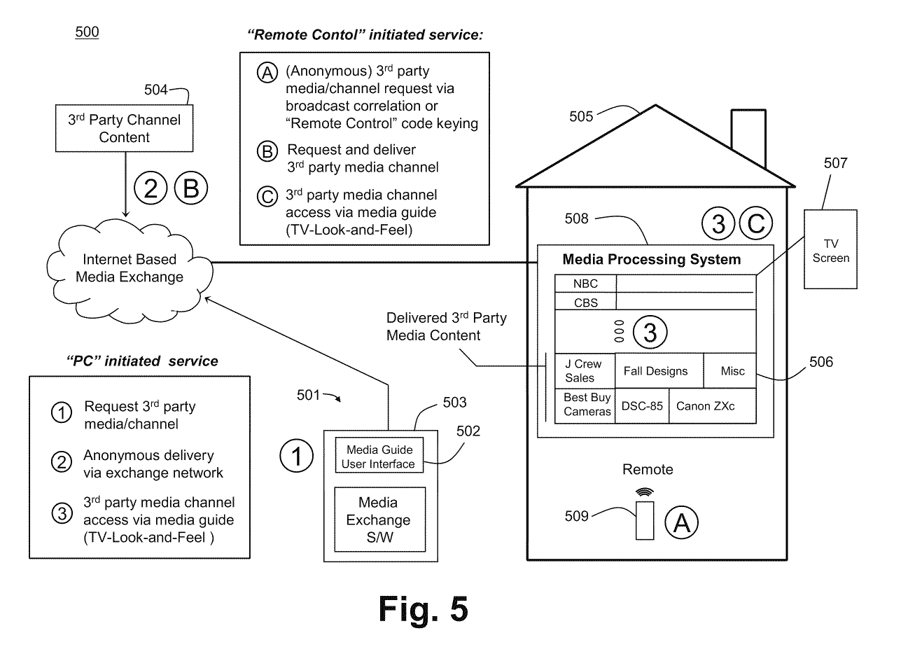

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user Interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

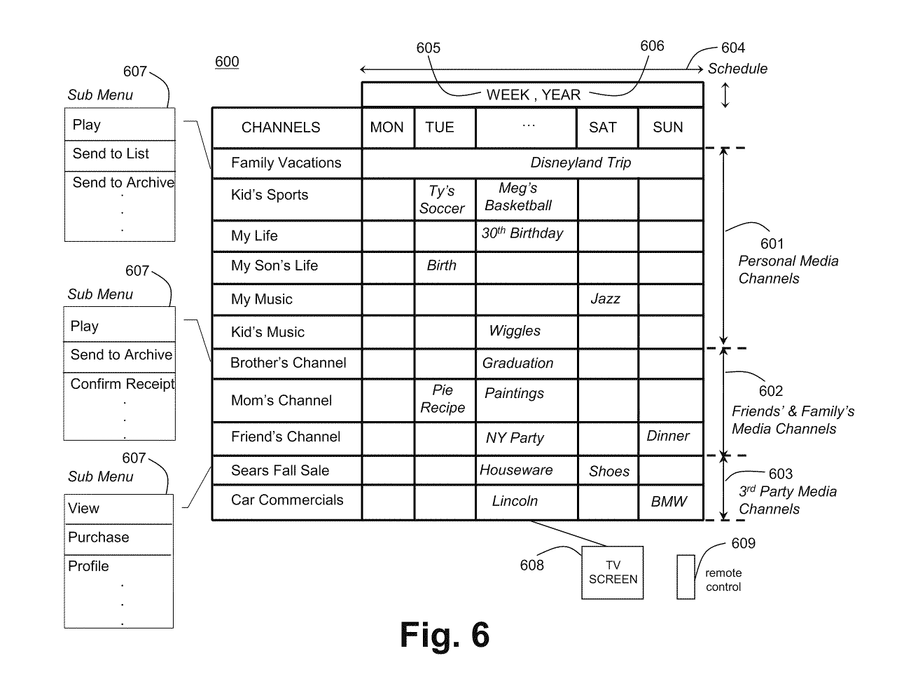

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

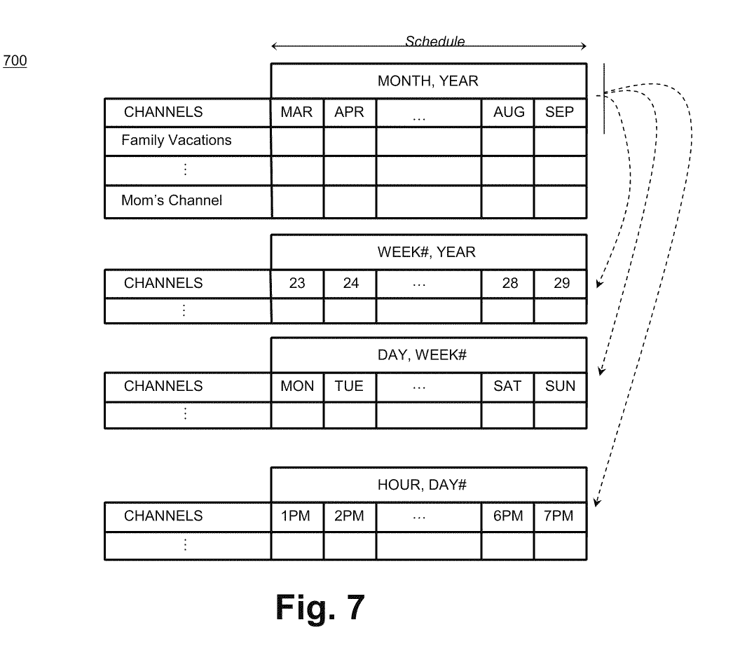

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

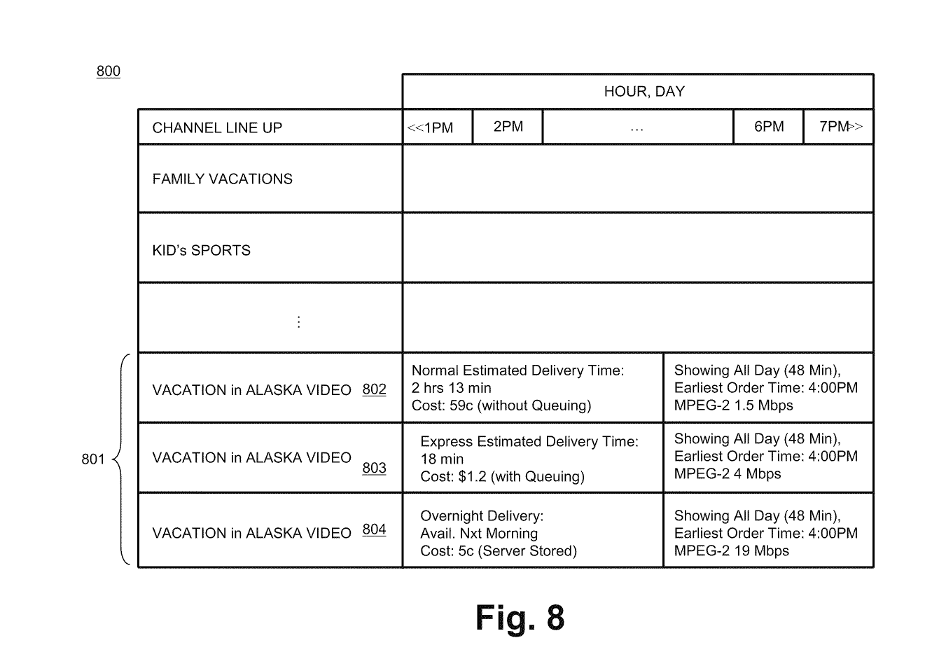

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

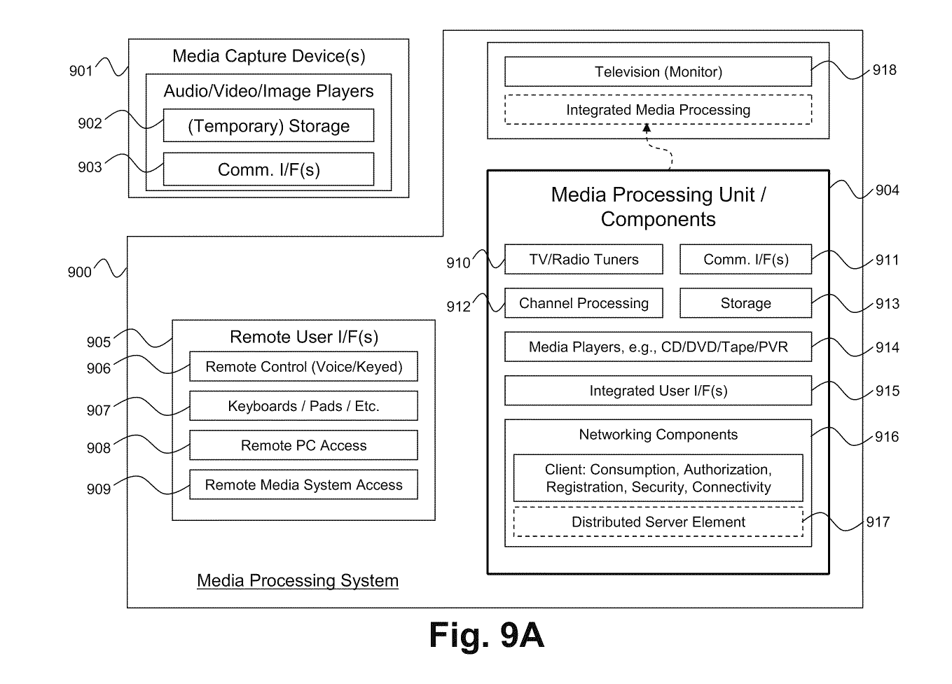

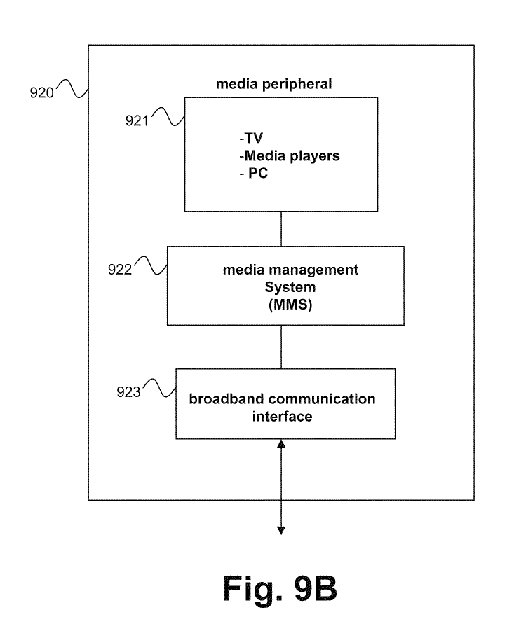

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

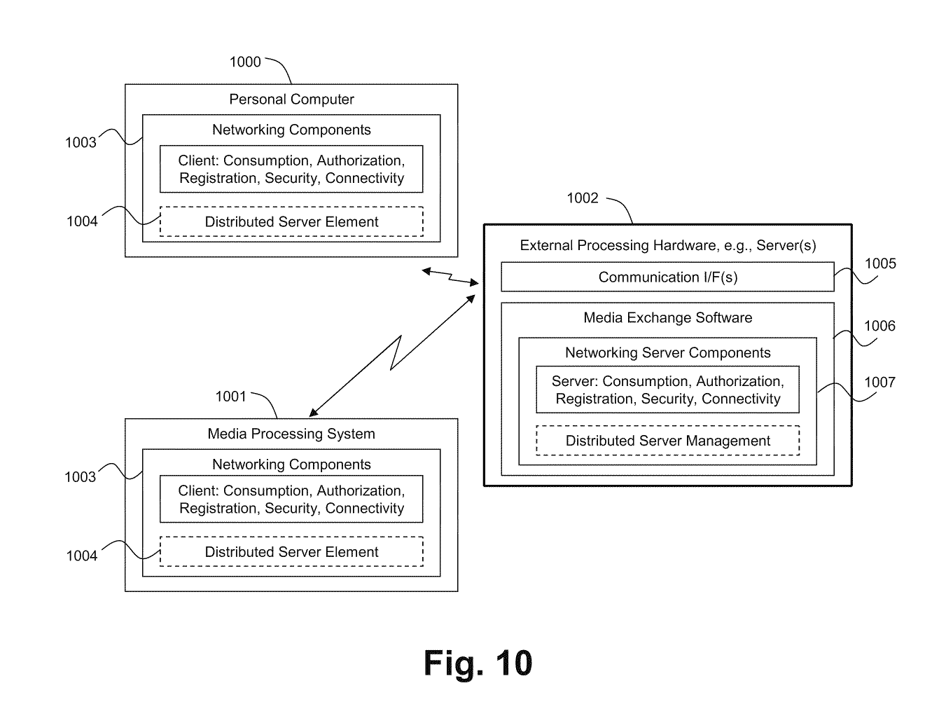

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

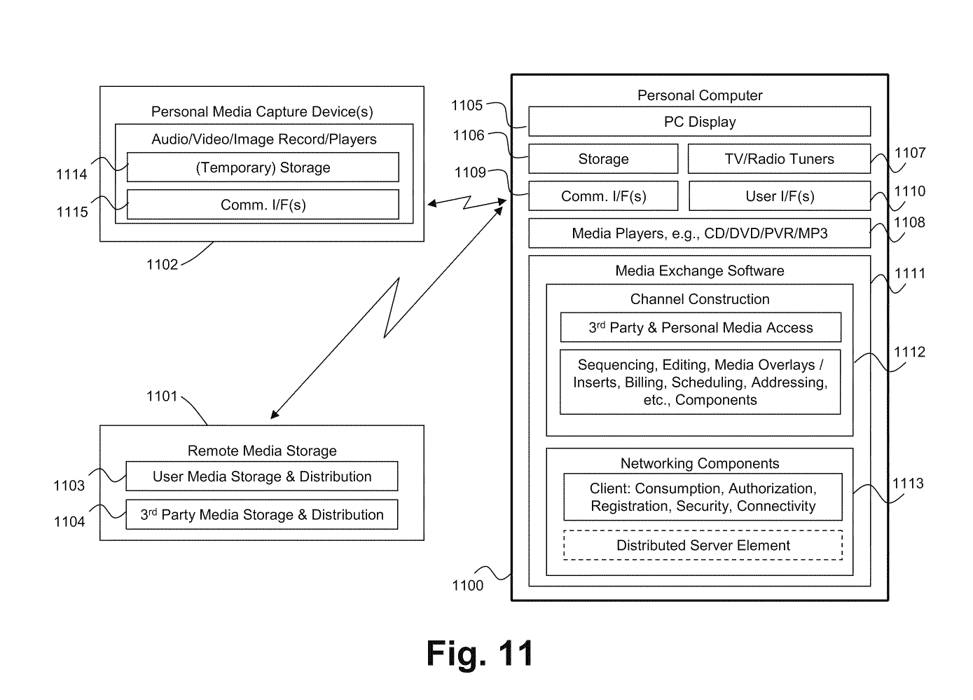

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Various embodiments of the present invention include a system and method for supporting personal streaming and broadcast channels in a media exchange network, as described above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1-25. (canceled)

26. A system supporting the communication of media content in a communication network, the system comprising:
at least one processor arranged for operably coupling to a first display device to enable consumption of media content, to at least one first media peripheral for production of media content, and to a first storage for storing media content, the at least one processor, during operation, communicatively coupling the first display device, the at least one first media peripheral, the first storage, and the communication network, the at least one processor operable to, at least:
cause display, on the first display device, of a user interface comprising a graphical representation of at least one user defined media channel, the at least one user defined media channel comprising a sequence of media content selected and time scheduled by a first user of a self-administered group of users;
transmit the at least one user defined media channel to one or more other systems at respective locations of other users of the self-administered group of users, via the communication network in a peer-to-peer manner, to enable display of the graphical representation of the at least one user defined media channel on a display device at each of the one or more other systems; and
automatically communicate the sequence of user selected media content between the at least one processor and the one or more other systems, via the communication network in a peer-to-peer manner, according to the time schedule of the at least one media channel.

27. The system according to claim 26, wherein the graphical user interface enables a user to immediately establish communication of media content between the system and the one or more other systems.

28. The system according to claim 26, wherein the self-administered group of users comprises the user at the first location and the users of the one or more other systems.

29. The system according to claim 26, wherein one of the one or more other systems comprises a second media peripheral, and the at least one user defined media channel comprises a scheduled time interval of communication of media content from the second media peripheral of the one other system to the first display device.

30. The system according to claim 29, wherein the second media peripheral is a video camera and the media content is video from the video camera for consumption in a real-time manner.

31. The system according to claim 29, wherein the at least one media channel comprises a scheduled time interval of concurrent communication of media content from the at least one first media peripheral to the second display device and communication of media content from the second media peripheral of the one other system to the first display device.

32. The system according to claim 26, wherein the communication network comprises one or more of a cable infrastructure, a satellite network infrastructure, a digital subscriber line (DSL) infrastructure, an Internet infrastructure, an intranet infrastructure, a wired infrastructure, and/or a wireless infrastructure.

33. The system according to claim 26, wherein the communication network comprises the Internet.

34. The system according to claim 26, wherein consumption comprises displaying one or both of a still image and video.

35. The system according to claim 26, wherein the at least one first media peripheral comprises one or more of a digital camera, a digital camcorder, a video camera, a television, a personal computer, a CD player, a home juke-box, a multi-media gateway device, a multi-media personal digital assistant, a DVD player, a tape player, a microphone, and/or a MP3 player.

36. The system according to claim 26, wherein the at least one processor is operable to, at least, initiates a request to communicate media content with the second home upon determining that a certain event has occurred at the first location.

37. The system according to claim 36, wherein the certain event comprises one or more of a door bell button press, detection of motion, detection of smoke, and/or detection of fire.
